(19) United States
(12) Patent Application Publication
(10) Pub. No.: US 2023/0324503 A1
(43) Pub. Date: Oct. 12, 2023

(54) DETERMINATION DEVICE, DETERMINATION METHOD, AND DETERMINATION SYSTEM

(71) Applicant: KABUSHIKI KAISHA TOKAI RIKA DENKI SEISAKUSHO, Aichi (JP)

(72) Inventors: Kazuki NAIKI, Aichi (JP); Tadashi FUKAGAI, Aichi (JP); Masateru FURUTA, Aichi (JP); Yuki KONO, Aichi (JP); Keigo KAGIMOTO, Aichi (JP); Satoshi NAGAMIZO, Aichi (JP)

(73) Assignee: KABUSHIKI KAISHA TOKAI RIKA DENKI SEISAKUSHO, Aichi (JP)

(21) Appl. No.: 18/089,677

(22) Filed: Dec. 28, 2022

(30) Foreign Application Priority Data
Mar. 23, 2022 (JP) 2022-046585
Jun. 29, 2022 (JP) 2022-104515

(51) Int. Cl. G01S 5/14; G01S 5/02

(52) U.S. Cl. CPC G01S 5/14; G01S 5/02213

(57) ABSTRACT

There is provided a determination device comprising a determination section configured to determine an area where a portable device is positioned, on a basis of wireless communication between a plurality of first wireless communication devices installed at different portions of a mobile object and a second wireless communication device installed in a portable device, in conformity with a designated communication standard, wherein the determination section determines the area where the portable device is positioned, by using different determination expressions depending on the respective first wireless communication devices, each of which has successfully calculated an RSSI with regard to a signal received from the second wireless communication device through wireless communication compliant with the designated communication standard and a determination target area.

### CROSS REFERENCE TO RELATED APPLICATION(S)

This application is based upon and claims benefit of priority from Japanese Patent Application No. 2022-046585, filed on Mar. 23, 2022, and Japanese Patent Application No. 2022-104515, filed on Jun. 29, 2022, the entire contents of which are incorporated herein by reference.

### BACKGROUND

The present invention relates to a determination device, a determination method, and a determination system.

In recent years, technologies of estimating a position of a target device through wireless communication have been developed. For example, JP 2021-099289A discloses a technology of performing wireless communication between a wireless communication device installed in a portable device and a plurality of wireless communication devices installed in a vehicle, and estimating the position of the portable device on the basis of intersections of directions of arrival of radio waves from the portable device. The intersections are estimated on the basis of the wireless communication.

### SUMMARY

However, when using the technology disclosed in JP 2021-099289A, there are the plurality of intersections of directions of arrival of radio waves in a vertical direction, and this may deteriorate the position estimation accuracy. In addition, the position estimation accuracy deteriorates drastically in the case where a calculated ranging value acquired by a wireless communication device is longer than an actual length due to an effect of an obstacle and the like.

Accordingly, the present invention is made in view of the aforementioned issues, and an object of the present invention is to determine a position of a target device with higher accuracy.

To solve the above described problem, according to an aspect of the present invention, there is provided a determination device comprising a determination section configured to determine an area where a portable device is positioned, on a basis of wireless communication between a plurality of first wireless communication devices installed at different portions of a mobile object and a second wireless communication device installed in a portable device, in conformity with a designated communication standard, wherein the determination section determines the area where the portable device is positioned, by using different determination expressions depending on the respective first wireless communication devices, each of which has successfully calculated an RSSI with regard to a signal received from the second wireless communication device through wireless communication compliant with the designated communication standard and a determination target area.

To solve the above described problem, according to another aspect of the present invention, there is provided a determination method comprising causing a processor to determine an area where a portable device is positioned, on a basis of wireless communication between a plurality of first wireless communication devices installed at different portions of a mobile object and a second wireless communication device installed in a portable device, in conformity with a designated communication standard, wherein the determination further includes determining the area where the portable device is positioned, by using different determination expressions depending on the respective first wireless communication devices, each of which has successfully calculated an RSSI with regard to a signal received from the second wireless communication device through wireless communication compliant with the designated communication standard and a determination target area.

To solve the above described problem, according to another aspect of the present invention, there is provided determination system comprising: a plurality of first wireless communication devices installed at different portions of a mobile object; a second wireless communication device installed in a portable device; and a determination section configured to determine an area where the portable device is positioned, on a basis of wireless communication between the respective first wireless communication devices and the second wireless communication device in conformity with a designated communication standard, wherein the determination device determines the area where the portable device is positioned, by using different determination expressions depending on the respective first wireless communication devices, each of which has successfully calculated an RSSI with regard to a signal received from the second wireless communication device through wireless communication compliant with the designated communication standard and a determination target area.

As described above, according to the present invention, it is possible to determine a position of a target device with higher accuracy.

### BRIEF DESCRIPTION OF THE DRAWINGS

FIG. 1 is a block diagram illustrating a configuration example of a determination system 1 according to an embodiment of the present invention.

FIG. 2 is a diagram illustrating an example of disposing first wireless communication devices 110 according to the embodiment.

FIG. 3 is a diagram for describing a situation where a difference between ranging values according to the embodiment is very small.

FIG. 4 is a diagram for describing an effect of area determination based on RSSIs according to the embodiment.

FIG. 5 is a flowchart illustrating an example of a flow of area determination of a portable device 20 by the determination system 1 according to the embodiment.

FIG. 6 is a flowchart illustrating an example of a flow of area determination of the portable device 20 by a determination section 125 according to the embodiment.

FIG. 7 is a flowchart illustrating the example of the flow of area determination of the portable device 20 by the determination section 125 according to the embodiment.

FIG. 8 is a flowchart illustrating the example of the flow of area determination of the portable device 20 by the determination section 125 according to the embodiment.

FIG. 9 is a flowchart illustrating the example of the flow of area determination of the portable device 20 by the determination section 125 according to the embodiment.

### DETAILED DESCRIPTION OF THE EMBODIMENT(S)

Hereinafter, referring to the appended drawings, preferred embodiments of the present invention will be described in detail. It should be noted that, in this specification and the appended drawings, structural elements that have substantially the same function and structure are denoted with the same reference numerals, and repeated explanation thereof is omitted.

### 1. Embodiment

### 1.1.1. System Configuration Example

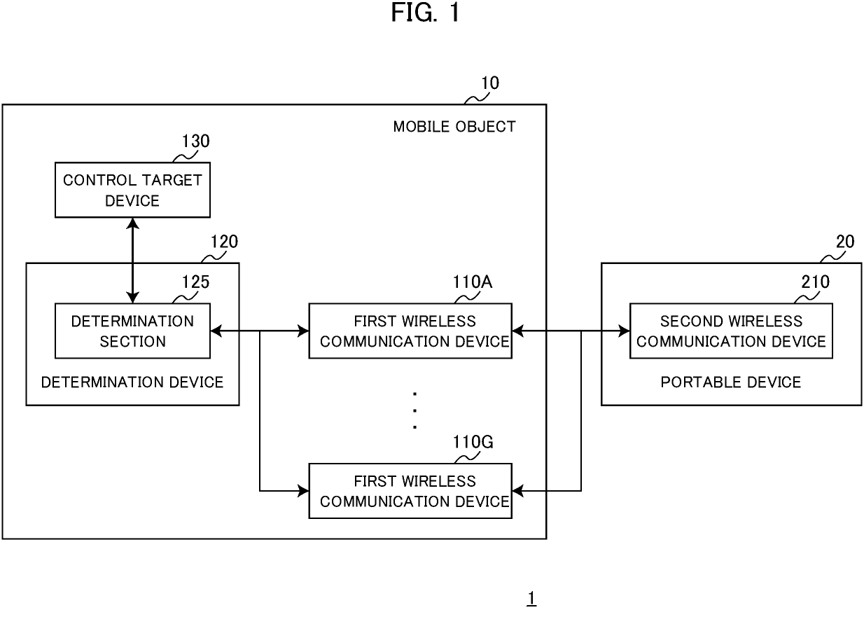

First, a configuration example of a determination system 1 according to an embodiment of the present invention will be described. FIG. 1 is a block diagram illustrating the configuration example of the determination system 1 according to the embodiment of the present invention.

As illustrated in FIG. 1, the determination system 1 according to the present embodiment includes a mobile object 10 and a portable device 20.

### Mobile Object 10

The mobile object 10 according to the present embodiment may be a means of transportation having a space for passengers (for example, a vehicle cabin in a case of a vehicle) such as a vehicle, an airplane, a ship, or the like, for example.

As illustrated in FIG. 1, the mobile object 10 according to the present embodiment may include a plurality of first wireless communication devices 110, a determination device 120, and a control target device 130.

### First Wireless Communication Device 110

The respective first wireless communication devices 110 are installed at different portions of the mobile object 10 according to the present embodiment.

In the case of the example illustrated in FIG. 1, the mobile object 10 includes seven first wireless communication devices 110A to 110G. However, the number of first wireless communication devices 110 installed in/on the mobile object 10 is not limited to the above-described example.

Each of the first wireless communication devices 110 according to the present embodiment performs wireless communication with a second wireless communication device 210 installed in the portable device 20 in conformity with a designated communication standard.

For example, each of the first wireless communication devices 110 according to the present embodiment calculates an RSSI of a signal received from the second wireless communication device through wireless communication compliant with the designated communication standard.

In addition, for example, each of the first wireless communication devices 110 according to the present embodiment performs ranging (a process of estimating a distance between the first wireless communication device 110 and the second wireless communication device 210) based on wireless communication with the second wireless communication device 210 in conformity with a designated communication standard.

Each of the first wireless communication devices 110 according to the present embodiment outputs a calculated RSSI and a ranging value calculated through the ranging (an estimated value of the distance between the first wireless communication device 110 and the second wireless communication device 210) to the determination device 120.

Examples of the designated communication standard according to the present embodiment include ultra-wideband (UWB) wireless communication.

Each of the first wireless communication devices 110 according to the present embodiment may calculate the ranging value through the technology disclosed in JP 2021-099289A or the like, for example.

Note that, the designated communication standard according to the present embodiment is not limited to the ultra-wideband wireless communication. Any standards capable of estimating a distance between the first wireless communication devices 110 and the second wireless communication device 210 may be adopted as the designated communication standard according to the present embodiment.

### Determination Device 120

The determination device 120 according to the present embodiment includes a determination section 125 configured to determine an area where the portable device 20 is positioned, on the basis of wireless communication between the respective first wireless communication devices and the second wireless communication device in conformity with the designated communication standard.

In addition, one of features of the determination section 125 according to the present embodiment is to determine the area where the portable device 20 is positioned, by using different determination expressions depending on the respective first wireless communication devices 110, each of which has successfully calculated an RSSI with regard to a signal received from the second wireless communication device 210 through the wireless communication compliant with the designated communication standard and a determination target area.

Note that, details of the area determination performed by the determination section 125 according to the present embodiment will be described later.

In addition, the determination section 125 according to the present embodiment may control behavior of the control target device 130 on the basis of a result of the area determination.

For example, the determination section 125 may permit an engine (an example of the control target device 130) of the mobile object 10 to start in the case where it is determined that the portable device 20 is positioned in the vehicle cabin of the mobile object 10.

Alternatively, for example, in the case where it is determined that the portable device 20 is positioned in a trunk of the mobile object 10, the determination section 125 may cause a sound output device (an example of the control target device 130) of the mobile object 10 to output a message indicating that the portable device 20 is positioned in the trunk.

Alternatively, for example, in the case where it is determined that the portable device 20 is positioned near an outside of the mobile object 10, the determination section 125 may instruct a lock device (an example of the control target device 130) to be opened. The lock device is installed in a door of the mobile object 10.

The functions of the determination section 125 according to the present embodiment are implemented by various kinds of processors.

### Control Target Device 130

The control target device 130 according to the present embodiment may be various kinds of devices that perform designated behavior under control based on a result of determination made by the determination device 120.

For example, the control target device 130 according to the present embodiment may be the engine, the lock device of the door, the sound output device, a display device, lighting equipment or the like.

### Portable Device 20

The portable device 20 according to the present embodiment is carried by a user of the mobile object 10 (such as an owner of the mobile object 10 or a person who has permission from the owner to use the mobile object 10).

As illustrated in FIG. 1, the portable device 20 according to the present embodiment includes at least the second wireless communication device 210.

### Second Wireless Communication Device 210

The second wireless communication device 210 according to the present embodiment performs wireless communication with the respective first wireless communication devices 110 installed in the mobile object 10 in conformity with the designated communication standard. In addition, the second wireless communication device 210 according to the present embodiment performs ranging in cooperation with the respective first wireless communication devices 100 installed in the mobile object 10.

The configuration example of the determination system 1 according to the present embodiment has been described above. Note that, the configuration described above with reference to FIG. 1 is a mere example. The configuration of the determination system 1 according to the present embodiment is not limited thereto.

For example, each of the mobile object 10 and the portable device 20 may further include a structural element for performing wireless communication compliant with another communication standard that is different from the designated communication standard described above. In this case, the determination section 125 may authenticate the portable device 20 on the basis of the wireless communication compliant with the other communication standard and may control behavior of the control target device 130 further on the basis of a result of the authentication.

The configuration of the determination system 1 according to the present embodiment may be flexibly modified in accordance with specifications, operations, and the like.

### 1.2. Example of Disposing First Wireless Communication Devices 110

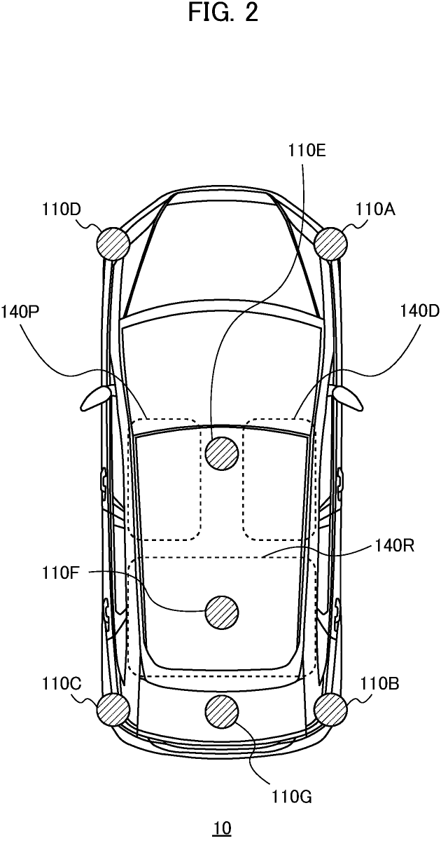

Next, an example of disposing the first wireless communication devices 110 according to the present embodiment will be described. FIG. 2 is a diagram illustrating the example of disposing the first wireless communication devices 110 according to the present embodiment.

In the case of the example illustrated in FIG. 2, the seven first wireless communication devices 110A to 110G are disposed at different portions of the mobile object 10.

More specifically, the first wireless communication device 110A is disposed on a right side of a front bumper of the mobile object 10. The first wireless communication device 110B is disposed on a right side of a rear bumper of the mobile object 10. The first wireless communication device 110C is disposed on a left side of the rear bumper of the mobile object 10. The first wireless communication device 110D is disposed on a left side of the front bumper of the mobile object 10.

In addition, the first wireless communication device 110E is disposed near a front middle portion (for example, between a driver’s seat 140D and a front passenger seat 140P) in the vehicle cabin of the mobile object 10. The first wireless communication device 110F is disposed near a rear middle portion (for example, in the middle of a rear seat 140R) in the vehicle cabin.

In addition, the first wireless communication device 110G is disposed in a specific space in the mobile object 10. Here, the specific space according to the present embodiment may be a space in the mobile object 10, and may be a space for which the area determination is performed separately from the vehicle cabin.

Examples of the specific space according to the present embodiment include the trunk (luggage compartment). Note that, in the case where the specific space is the trunk, the trunk may be a (closed) space that is clearly separated from the vehicle cabin, or may be an (open) space that is connected with the vehicle cabin.

Hereinafter, a case where the specific space according to the present embodiment is the trunk will be described as a major example. In other words, the first wireless communication device 110G is disposed in the trunk of the mobile object 10.

However, the specific space according to the present embodiment is not limited to the trunk. For example, the specific space may be a partial space or the like in the vehicle cabin such as a glove compartment in the vehicle cabin.

At least one or more first wireless communication devices 110 according to the present embodiment may be disposed in the vehicle cabin in the mobile object 10, in the specific space in the mobile object 10, and on an exterior of the mobile object 10.

The determination section 125 of the determination device 120 according to the present embodiment determines whether the portable device 20 is positioned in the vehicle cabin, in the specific space, or on the exterior of the mobile object 10 on the basis of wireless communication between the second wireless communication device 210 and the respective first wireless communication devices 110 disposed as described above, in conformity with the designated communication standard.

### 1.3. Determination Example

Next, a detailed example of the area determination performed by the determination section 125 according to the present embodiment will be described.

One of features of the determination section 125 according to the present embodiment is to determine the area where the portable device 20 is positioned, by using different determination expressions depending on the respective first wireless communication devices 110, each of which has successfully calculated an RSSI with regard to a signal received from the second wireless communication device 210 through the wireless communication compliant with the designated communication standard and a determination target area.

In this case, the determination section 125 determines the area where the portable device 20 is positioned, by using a weighted determination expression in which different weights are given to the respective first wireless communication devices 110, each of which has successfully calculated an RSSI with regard to a signal received from the second wireless communication device 210 through wireless communication compliant with the designated communication standard and a determination target area.

Next, a detailed example of determination will be described with reference to the layout of the first wireless communication devices 110 illustrated in FIG. 2.

For example, the determination section 125 determines whether the portable device 20 is positioned inside or outside the trunk (an example of the specific space) on the basis of respective RSSIs calculated by four first wireless communication devices 110 disposed near the trunk.

The four first wireless communication devices 110 may include the first wireless communication devices 110B and 110C that are disposed on the rear bumper of the mobile object 10, the first wireless communication device 110F that is disposed near the rear middle portion in the vehicle cabin of the mobile object 10, and the first wireless communication device 110G that is disposed in the trunk of the mobile object 10.

More specifically, the determination section 125 may determine whether the portable device 20 is positioned inside or outside the trunk by using a determination expression (1) listed below.

$$\text{y} = \text{b + wrB} ∗ \text{RB+ wrC} ∗ \text{RC + wrF} ∗ \text{RF + wrG} ∗ \text{RG} \qquad \text{(1)}$$

In the determination expression (1), b represents a constant, wrB to wrG represent respective weights given to RSSIs calculated by the respective first wireless communication devices 110B to 110G, and RB to RG represent the respective RSSIs calculated by the first wireless communication devices 110B to 110G.

In this case, the determination section 125 may determine that the portable device 20 is positioned inside the trunk if y > 0, and the determination section 125 may determine that the portable device 20 is positioned outside the trunk if y ≤ 0. On the other hand, the determination section 125 may determine that the portable device 20 is positioned inside the trunk if y ≤ 0, and the determination section 125 may determine that the portable device 20 is positioned outside the trunk if y > 0. The constant b is appropriately set in such a manner that each of the above-described conditions is satisfied.

Note that, for example, it is possible to improve the determination accuracy of the determination expression (1) listed above, when increasing the weight wrG given to an RSSI calculated by the first wireless communication device 110G that is the nearest to the trunk.

Alternatively, for example, the determination section 125 determines whether the portable device 20 is positioned inside the vehicle cabin or on an outer right side of the vehicle cabin on the basis of respective RSSIs calculated by four first wireless communication devices 110 closer to the right side of the mobile object 10.

The four first wireless communication devices 110 may include the first wireless communication device 110A that is disposed on the right side of the front bumper of the mobile object 10, the first wireless communication device 110B that is disposed on the right side of the rear bumper of the mobile object 10, and the first wireless communication devices 110E and 110F that are disposed inside the vehicle cabin of the mobile object 10.

More specifically, the determination section 125 may determine whether the portable device 20 is positioned inside or outside the vehicle cabin by using a determination expression (2) listed below.

$$\text{y} = \text{b + wrA} ∗ \text{RA+ wrB} ∗ \text{RB + wrE} ∗ \text{RE + wrF} ∗ \text{RF} \qquad \text{(2)}$$

In the determination expression (2), b represents a constant, wrA to wrF represent respective weights given to RSSIs calculated by the respective first wireless communication devices 110A to 110F, and RA to RF represent the respective RSSIs calculated by the first wireless communication devices 110A to 110F.

In this case, the determination section 125 may determine that the portable device 20 is positioned on the outer right side of the vehicle cabin (of the mobile object 10) if y > 0, and the determination section 125 may determine that the portable device 20 is positioned inside the vehicle cabin if y ≤ 0. On the other hand, the determination section 125 may determine that the portable device 20 is positioned on the outer right side of the vehicle cabin (of the mobile object 10) if y ≤ 0, and the determination section 125 may determine that the portable device 20 is positioned inside the vehicle cabin if y > 0. The constant b is appropriately set in such a manner that each of the above-described conditions is satisfied.

Note that, it is also possible to improve the determination accuracy of the determination expression (2) listed above when weights wrA and wrB are negative numbers and weights wrE and wrF are positive numbers. The weights wrA and wrB are given to respective RSSIs calculated by the first wireless communication devices 110A and 110B disposed on right portions of the exterior of the mobile object 10. The weights wrE and wrF are given to respective RSSIs calculated by the first wireless communication devices 110E and 110F disposed inside the vehicle cabin of the mobile object 10.

The detailed example of the area determination using the determination expression in which weights are given to the RSSIs according to the present embodiment has been described above.

However, the weighted determination expression according to the present embodiment is not limited thereto. In the weighted determination expression according to the present embodiment, different weights may be given to respective ranging values acquired by the first wireless communication devices 110.

In this case, the determination section 125 may determine the area where the portable device 20 is positioned, by using a weighted determination expression in which different weights are given to the respective first wireless communication devices 110 on the basis of first wireless communication devices 110 that have successfully performed ranging with regard to the second wireless communication device 210 and a determination target area.

For example, the determination section 125 may use a determination expression (3) listed below when determining whether the portable device 20 is positioned inside or outside the trunk on the basis of respective ranging values acquired by the first wireless communication devices 110B, 110C, 110F, and 110G.

$$\text{y} = \text{b + wlB} ∗ \text{LB+ wlC} ∗ \text{LC + wlF} ∗ \text{LF + wlG} ∗ \text{LG} \qquad \text{(3)}$$

In the determination expression (3), b represents a constant, wlB to w1G represent respective weights given to ranging values acquired by the respective first wireless communication devices 110B to 110G, and LB to LG represent the respective ranging values acquired by the first wireless communication devices 110B to 110G.

In this case, the determination section 125 may determine that the portable device 20 is positioned inside the trunk if y > 0, and the determination section 125 may determine that the portable device 20 is positioned outside the trunk if y ≤ 0. On the other hand, the determination section 125 may determine that the portable device 20 is positioned inside the trunk if y ≤ 0, and the determination section 125 may determine that the portable device 20 is positioned outside the trunk if y > 0. The constant b is appropriately set in such a manner that each of the above-described conditions is satisfied.

Note that, for example, it is possible to improve the determination accuracy of the determination expression (3) listed above, when increasing the weight w1G given to a ranging value acquired by the first wireless communication device 110G that is the nearest to the trunk.

Alternatively, the determination section 125 may use a determination expression (4) listed below when determining whether the portable device 20 is positioned inside the vehicle cabin or on an outer right side of the vehicle cabin on the basis of respective ranging values acquired by the first wireless communication devices 110A, 110B, 110E, and 110F.

$$\text{y} = \text{b + wlA} ∗ \text{LA+ wlB} ∗ \text{LB + wlE} ∗ \text{LE + wlF} ∗ \text{LF} \qquad \text{(4)}$$

In the determination expression (4), b represents a constant, w1A to w1F represent respective weights given to ranging values acquired by the respective first wireless communication devices 110A to 110F, and LA to LF represent the respective ranging values acquired by the first wireless communication devices 110A to 110F.

In this case, the determination section 125 may determine that the portable device 20 is positioned on the outer right side of the vehicle cabin (of the mobile object 10) if y > 0, and the determination section 125 may determine that the portable device 20 is positioned inside the vehicle cabin if y ≤ 0. On the other hand, the determination section 125 may determine that the portable device 20 is positioned on the outer right side of the vehicle cabin (of the mobile object 10) if y ≤ 0, and the determination section 125 may determine that the portable device 20 is positioned inside the vehicle cabin if y > 0. The constant b is appropriately set in such a manner that each of the above-described conditions is satisfied.

Note that, for example, it is also possible to improve the determination accuracy of the determination expression (4) listed above when weights w1A and w1B are negative numbers and weights wlE and w1F are positive numbers. The weights w1A and w1B are given to respective ranging values acquired by the first wireless communication devices 110A and 110B disposed on right portions of the exterior of the mobile object 10. The weights wlE and w1F are given to respective ranging values acquired by the first wireless communication devices 110E and 110F disposed inside the vehicle cabin of the mobile object 10.

The detailed example of the area determination using the weighted determination expression in which weights are given to the ranging values according to the present embodiment has been described above.

Next, a detailed example of area determination using a weighted determination expression in which weights are given to RSSIs and ranging values according to the present embodiment has been described above.

For example, the determination section 125 may use a determination expression (5) listed below when determining whether the portable device 20 is positioned inside or outside the trunk on the basis of ranging values and RSSIs acquired by the respective first wireless communication devices 110B, 110C, 110F, and 110G.

$$\begin{matrix}\text{y} = \text{b + wlB} ∗ \text{LB+ wlC} ∗ \text{LC + wlF} ∗ \text{LF + wlG} ∗ \text{LG + wrB} ∗ \text{RB+} \\ \text{wrC} ∗ \text{RC + wrF} ∗ \text{RF + wrG} ∗ \text{RG}\end{matrix} \qquad \text{(5)}$$

In the determination expression (5), b represents a constant, wrB to wrG represent respective weights given to RSSIs calculated by the respective first wireless communication devices 110B to 110G, and RB to RG represent the respective RSSIs calculated by the first wireless communication devices 110B to 110G. In addition, in the determination expression (5), w1B to w1G represent respective weights given to ranging values acquired by the respective first wireless communication devices 110B to 110G, and LB to LG represent the respective ranging values acquired by the first wireless communication devices 110B to 110G.

In this case, the determination section 125 may determine that the portable device 20 is positioned inside the trunk if y > 0, and the determination section 125 may determine that the portable device 20 is positioned outside the trunk if y ≤ 0. On the other hand, the determination section 125 may determine that the portable device 20 is positioned inside the trunk if y ≤ 0, and the determination section 125 may determine that the portable device 20 is positioned outside the trunk if y > 0. The constant b is appropriately set in such a manner that each of the above-described conditions is satisfied.

Note that, for example, it is possible to improve the determination accuracy of the determination expression (5) listed above, when increasing the weights wrG and w1G related to the first wireless communication device 110G that is the nearest to the trunk.

Note that, the weights wrB to wrG given to the RSSIs may be different from the weights w1B to w1G given to the ranging values.

For example, the weights wrB to wrG given to the RSSIs may be heavier than the weights w1B to w1G given to the ranging values.

By setting the weights as described above, it is expected to obtain an effect of further improving the determination accuracy at a boundary between spaces as will be described later.

Alternatively, the determination section 125 may use a determination expression (6) listed below when determining whether the portable device 20 is positioned inside the vehicle cabin or on an outer right side of the vehicle cabin on the basis of ranging values and RSSIs acquired by the respective first wireless communication devices 110A, 110B, 110E, and 110F.

$$\begin{matrix}\text{y} = \text{b + wlA} ∗ \text{LA+ wlB} ∗ \text{LB + wlE} ∗ \text{LE + wlF} ∗ \text{LF + wrA} ∗ \text{RA+} \\ \text{wrB} ∗ \text{RB + wrE} ∗ \text{RE + wrF} ∗ \text{RF}\end{matrix} \qquad \text{(6)}$$

In the determination expression (6), b represents a constant, wrA to wrF represent respective weights given to RSSIs calculated by the respective first wireless communication devices 110A to 110F, and RA to RF represent the respective RSSIs calculated by the first wireless communication devices 110A to 110F. In addition, in the determination expression (6) listed above, wlA to w1F represent respective weights given to ranging values acquired by the respective first wireless communication devices 110A to 110F, and LA to LF represent the respective ranging values acquired by the first wireless communication devices 110A to 110F.

In this case, the determination section 125 may determine that the portable device 20 is positioned on the outer right side of the vehicle cabin (of the mobile object 10) if y > 0, and the determination section 125 may determine that the portable device 20 is positioned inside the vehicle cabin if y ≤ 0. On the other hand, the determination section 125 may determine that the portable device 20 is positioned on the outer right side of the vehicle cabin (of the mobile object 10) if y ≤ 0, and the determination section 125 may determine that the portable device 20 is positioned inside the vehicle cabin if y > 0. The constant b is appropriately set in such a manner that each of the above-described conditions is satisfied.

Note that, for example, it is also possible to improve the determination accuracy of the determination expression (6) listed above when weights wrA, wrB, wlA, and wlB are negative numbers and weights wrE, wrF, wlE, and w1F are positive numbers. The weights wrA, wrB, wlA, and w1B are related to the first wireless communication devices 110A and 110B disposed on the right portions of the exterior of the mobile object 10. The weights wrE, wrF, wlE, and w1F are related to the first wireless communication devices 110E and 110F disposed inside the vehicle cabin of the mobile object 10.

Note that, the weights wrA to wrF given to the RSSIs may be different from the weights w1A to w1F given to the ranging values.

For example, the weights wrA to wrF given to the RSSIs may be heavier than the weights w1A to w1F given to the ranging values.

By setting the weights as described above, it is expected to obtain an effect of further improving the determination accuracy at the boundary between the spaces as will be described later.

The detailed examples of the weighted determination expressions according to the present embodiment have been described above.

Note that, the constant b and the respective weights in the above-listed determination expressions (1) to (6) may be found through a machine learning method such as a support vector machine (SVM). For example, when using the SVM, it is possible to derive the constant b and the weights wA to wG by finding a split straight line that optimizes determination of whether the portable device 20 is positioned inside or outside the trunk or the like.

In addition, as described above, the RSSIs or the ranging values may be set as targets of weighting, or both the RSSIs and the ranging values may be set as targets of weighting in the weighted determination expressions according to the present embodiment.

For example, in the case where the ranging values are used as the targets of weighting, it is possible to assure the determination accuracy by performing determination while using a ranging value that is normally acquired by another first wireless communication device 110 even if some of the first wireless communication devices 110 have failed to acquire ranging values or have acquired abnormal values due to effects of obstacles (human bodies, metal, or the like), a surrounding environment, and the like.

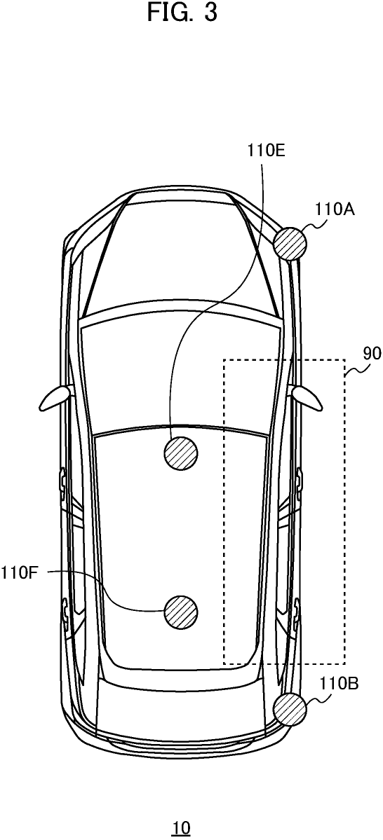

Note that, sometimes a difference between the acquired ranging values may be very small in a situation where the portable device 20 is positioned in a region that is very close to the boundary between the spaces such as a region near a window or the like serving as a portion of the door of the mobile object 10 like a region 90 illustrated in FIG. 3.

For example, in the case of the example illustrated in FIG. 3, a difference between two ranging values becomes very small. One of the two ranging values is calculated by each of the first wireless communication devices 110A, 110B, 110E, and 110F in a situation where the portable device 20 is positioned in the vehicle cabin and in the region 90 while the portable device 20 is very close to the window. The other of the two ranging values is calculated by each of the first wireless communication devices 110A, 110B, 110E, and 110F in a situation where the portable device 20 is positioned outside the vehicle cabin but in the region 90 while the portable device 20 is very close to the window. In this case, this may deteriorate the accuracy of determining whether the portable device 20 is positioned inside the vehicle cabin or on an outer right side of the vehicle cabin.

On the other hand, the RSSIs drastically decay due to transmission or diffraction even when an object interposed between devices that exchange signals is a transparent object such as a window. Therefore, it is possible to maintain high determination accuracy by performing determination using the RSSIs even in a situation where the portable device 20 is positioned in a region that is very close to the boundary between the spaces.

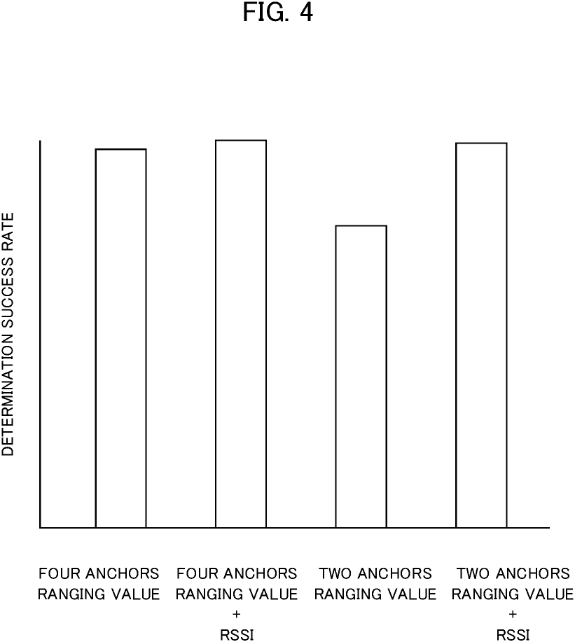

FIG. 4 is a diagram for describing an effect of area determination based on RSSIs according to the present embodiment.

Note that, sometimes the first wireless communication devices 110 may be referred to as anchors in the following description and in FIG. 4 to FIG. 9.

FIG. 4 illustrates determination success rates of determining whether the portable device 20 is positioned inside the vehicle cabin or on an outer right side of the vehicle cabin in the case where the portable device 20 is disposed at a plurality of spots in the region 90 under four conditions listed below.

Condition 1: Determine whether the portable device 20 is positioned inside the vehicle cabin or on an outer right side of the vehicle cabin by using the weighted determination expression using ranging values acquired by four anchors including the first wireless communication devices 110A, 110B, 110E, and 110F.

Condition 2: Determine whether the portable device 20 is positioned inside the vehicle cabin or on an outer right side of the vehicle cabin by using the weighted determination expression using RSSIs and ranging values acquired by the four anchors including the first wireless communication devices 110A, 110B, 110E, and 110F.

Condition 3: Determine whether the portable device 20 is positioned inside the vehicle cabin or on an outer right side of the vehicle cabin by using the weighted determination expression using ranging values acquired by two anchors including the first wireless communication devices 110E and 110F.

Condition 4: Determine whether the portable device 20 is positioned inside the vehicle cabin or on an outer right side of the vehicle cabin by using the weighted determination expression using RSSIs and ranging values acquired by the two anchors including the first wireless communication devices 110E and 110F.

With reference to FIG. 4, when the four anchors are used, the determination success rate obtained by using the weighted determination expression in which only the ranging values are weighted is almost equal to the determination success rate obtained by using the weighted determination expression in which both the ranging values and the RSSIs are weighted.

In addition, with reference to FIG. 4, when two anchors are used, the determination success rate obtained by using the weighted determination expression in which both the ranging values and the RSSIs are weighted is drastically higher than the determination success rate obtained by using the weighted determination expression in which only the ranging values are weighted.

In addition, the determination success rate obtained by using the weighted determination expression in which the ranging values and RSSIs acquired by the two anchors are weighted is almost equal to the determination success rate obtained by using the weighted determination expression in which the ranging values and RSSIs acquired by the two anchors are weighted.

Therefore, it is possible to maintain the high determination accuracy by performing determination using the RSSIs even in a situation where the portable device 20 is positioned in a region that is very close to the boundary between the spaces.

In addition, by performing determination using the RSSIs, it is possible to reduce the number of anchors to be used for the determination, and it is expected to obtain an effect of reducing cost.

### 1.4. Flow of Determination

Next, a flow of the area determination of the portable device 20 by the determination system 1 according to the present embodiment will be described.

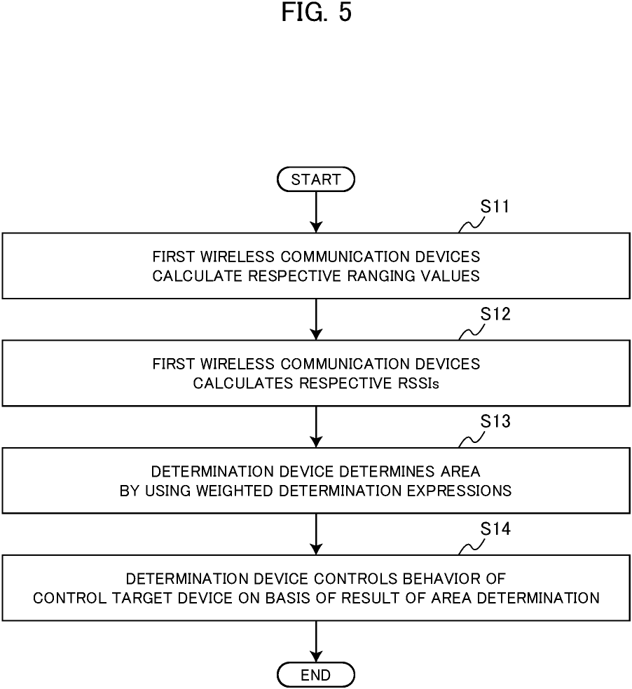

FIG. 5 is a flowchart illustrating an example of a flow of area determination of the portable device 20 by the determination system 1 according to the present embodiment.

In the case of the example illustrated in FIG. 5, the plurality of first wireless communication devices 110 first calculate respective ranging values by performing ranging based on wireless communication with the second wireless communication device 210 in conformity with the designated communication standard (Step S11).

Next, the plurality of first wireless communication devices 110 calculates respective RSSIs of signals received from the second wireless communication device 210 through wireless communication with the second wireless communication device 210 in conformity with the designated communication standard (Step S12).

Note that, for example, the signals from which the first wireless communication devices 110 calculate the RSSIs may be signals received from the second wireless communication device 210 during ranging.

Next, the determination device 120 determines an area (Step S13) by using the weighted determination expressions listed above, on the basis of the ranging values calculated in Step S11 and the RSSIs calculated in Step S12.

In addition, the determination device 120 controls behavior of the control target device 130 (Step S14) on the basis of a result of the area determination performed in Step S13.

The example of the flow of the area determination of the portable device 20 by the determination system 1 according to the present embodiment has been described above.

Next, a detailed example of the flow of the area determination according to the present embodiment will be described.

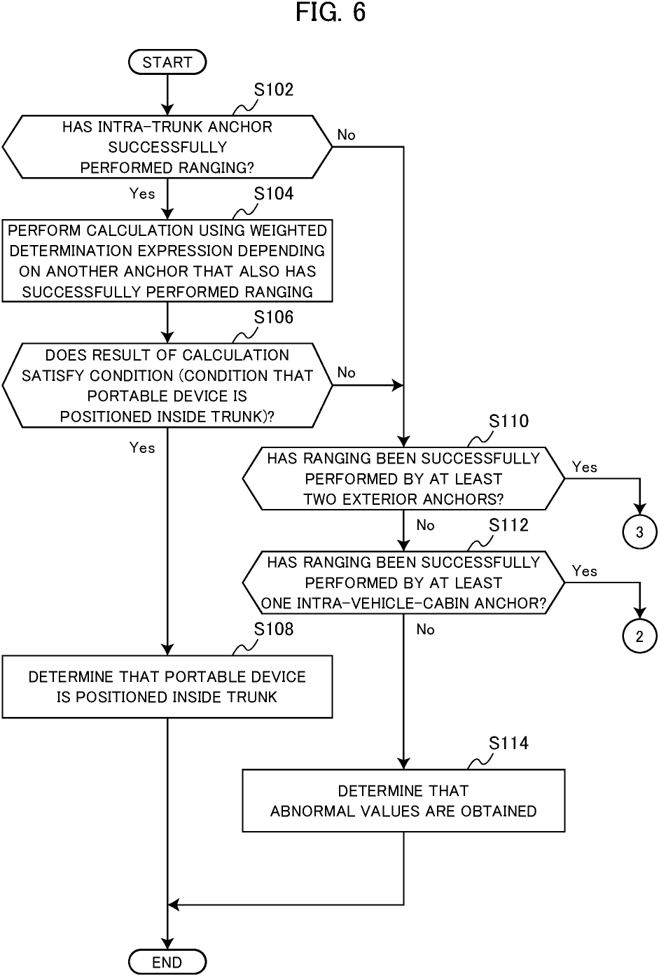

FIG. 6 to FIG. 9 is a flowchart illustrating an example of the flow of area determination of the portable device 20 by the determination section 125 according to the present embodiment.

Note that, FIG. 6 to FIG. 9 and the following description uses the same layout as the layout of the first wireless communication devices 110 illustrated in FIG. 2.

In addition, the weighted determination expressions used in processes illustrated in FIG. 6 to FIG. 9 may be determination expressions in which both ranging values and RSSIs are used.

In addition, sometimes the four first wireless communication devices 110A, 110B, 110C, and 110D may also be referred to as exterior anchors in the following description and in FIG. 6 to FIG. 9. Sometimes the first wireless communication devices 110E and 110F may also be referred to as intra-vehicle-cabin anchors. Sometimes the first wireless communication device 110G may also be referred to as an intra-trunk anchor.

First, description will be given with reference to FIG. 6. In the case of the example illustrated in FIG. 6, the determination section 125 first determines whether the intra-trunk anchor has successfully performed ranging between the intra-trunk anchor and the second wireless communication device 210 (Step S102).

Note that, the determination section 125 may determine that the ranging has been successfully performed in the case where the ranging values are calculated.

In the case where it is determined that the intra-trunk anchor has successfully performed ranging (Yes in Step S102), the determination section 125 performs a calculation using a weighted determination expression depending on another anchor that also has successfully performed ranging (Step S104).

For example, the determination section 125 may perform a calculation using the above-listed determination expression (5) in the case where ranging has been successfully performed by three first wireless communication devices 110B, 110C, and 110F. The first wireless communication devices 110B and 110C are disposed on the rear bumper of the mobile object 10. The first wireless communication device 110F is disposed near the rear middle portion in the vehicle cabin of the mobile object 10.

On the other hand, in the case where the ranging has not been successfully performed by at least one of the three anchors, the determination section 125 performs a calculation using different weighted determination expressions depending on the anchor(s) that have failed to perform ranging.

Next, the determination section 125 determines whether or not a condition (condition that the portable device 20 is positioned inside the trunk) is satisfied by a result of the calculation using the weighted determination expression (for example, y > 0 in the case of the determination expression (5) listed above) (Step S106).

Here, in the case where the result of the calculation satisfies the condition (condition that the portable device 20 is positioned inside the trunk), the determination section 125 determines that the portable device 20 is positioned inside the trunk (Step S 108), and the determination process ends.

On the other hand, the determination section 125 proceeds to a process of determining whether the portable device 20 is positioned inside or outside the vehicle cabin in the case where it is determined that the intra-trunk anchor has failed to perform ranging in Step S102 (No is Step S102) or in the case where the result of calculation does not satisfy the condition (condition that the portable device 20 is positioned inside the trunk) in Step S106 (No in Step S106).

As described above, the determination section 125 according to the present embodiment may determine whether or not the portable device 20 is positioned in the specific space, and then if it is determined that the portable device 20 is not positioned in the specific space, the determination device may determine whether the portable device 20 is positioned in the vehicle cabin or outside the mobile object 10.

The above-described process flow makes it possible to efficiently and accurately determine whether the portable device 20 is positioned inside or outside the vehicle cabin on the premise that the portable device 20 is not positioned in the specific space such as the trunk.

When determining whether the portable device 20 is positioned inside or outside the vehicle cabin, the determination section 125 first determines whether or not ranging has been successfully performed by at least two exterior anchors (Step S110).

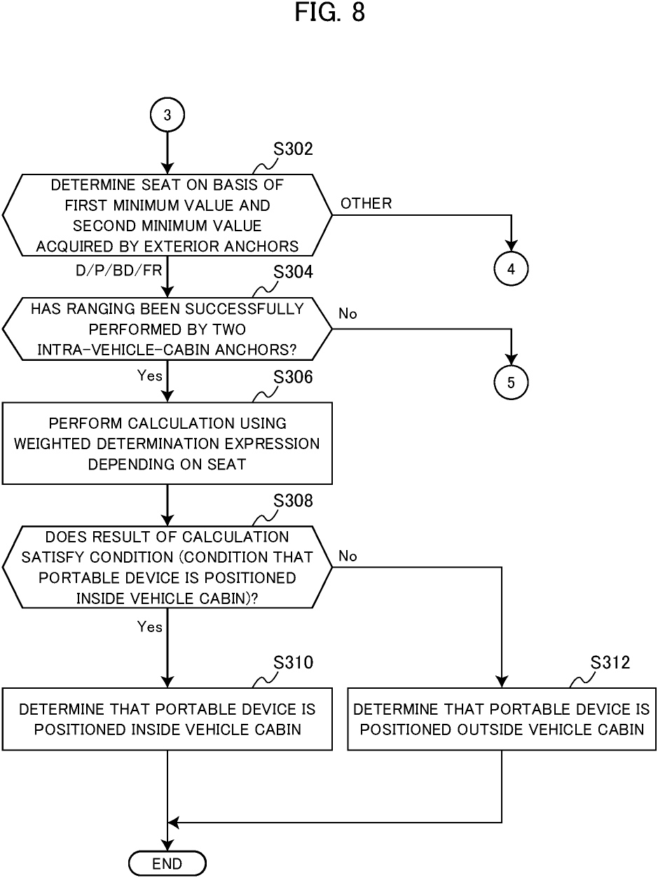

The determination section 125 proceeds to Step S302 illustrated in FIG. 8 in the case where it is determined that the ranging has been successfully performed by the at least two exterior anchors (Yes in Step S110).

On the other hand, the determination section 125 determines whether or not ranging has been successfully performed by at least one intra-vehicle-cabin anchor (Step S112) in the case where it has not been determined that the ranging has been successfully performed by the at least two exterior anchors (No in Step S110), that is, in the case where the ranging has not been successfully performed by three or more exterior anchors.

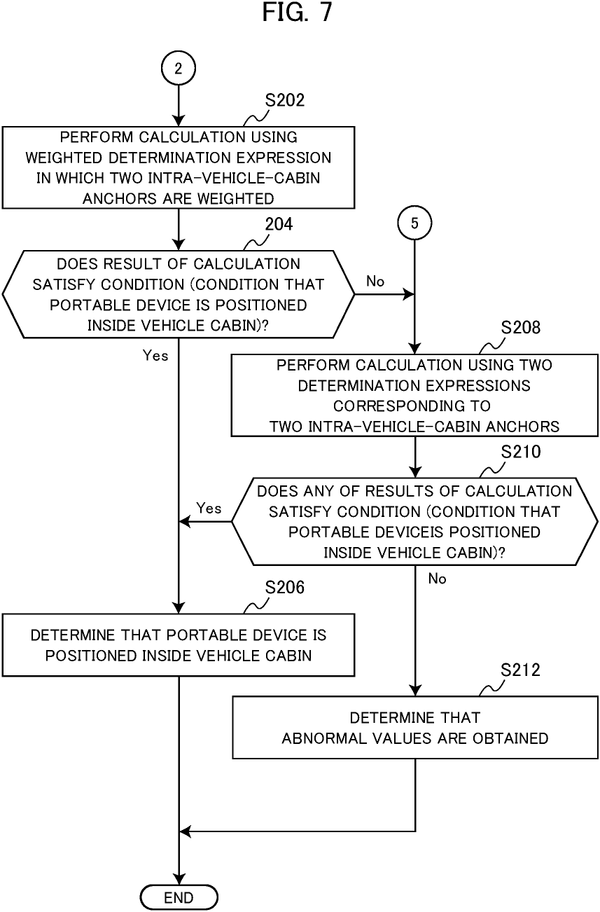

The determination section 125 proceeds to Step S202 illustrated in FIG. 7 in the case where it is determined that the ranging has been successfully performed by at least one intra-vehicle-cabin anchor (Yes in Step S112).

On the other hand, the determination section 125 determines that abnormal values are obtained (Step S114) and ends the determination process because many anchors disposed in the trunk, in the vehicle cabin, and on the exterior have failed to perform ranging in the case where it has not been determined that the ranging has been successfully performed by the at least one intra-vehicle-cabin anchor (No in Step S112), that is, in the case where both of the two intra-vehicle-cabin anchors have failed to perform ranging.

Next, description will continue with reference to FIG. 7. The determination section 125 performs a calculation using a weighted determination expression in which the two intra-vehicle-cabin anchors are weighted (Step S202) in the case where it is determined that the ranging has been successfully performed by at least one intra-vehicle-cabin anchor in Step S112 illustrated in FIG. 6 (Yes in Step S112).

The weighted determination expression in which the two intra-vehicle-cabin anchors are weighted may be a mathematical expression including a constant, respective ranging values calculated by the two intra-vehicle-cabin anchors, and weights given to the ranging values.

Next, the determination section 125 determines whether or not a result of the calculation obtained in Step S202 satisfies a condition (condition that the portable device 20 is positioned inside the vehicle cabin) (Step S204).

In the case where the result of the calculation satisfies the condition (condition that the portable device 20 is positioned inside the vehicle cabin) (Yes in Step S204), the determination section 125 determines that the portable device 20 is positioned inside the vehicle cabin (Step S206), and ends the determination process.

On the other hand, in the case where the result of the calculation does not satisfy the condition (condition that the portable device 20 is positioned inside the vehicle cabin) (No in Step S204), the determination section 125 performs a calculation using two determination expressions corresponding to the two intra-vehicle-cabin anchors (Step S208).

Each of the two determination expressions may be an expression that simply determines whether a ranging value calculated by one of the intra-vehicle-cabin anchors is large or small.

In the case where any of results of the calculation obtained in Step S208 satisfies the condition (condition that the portable device 20 is positioned inside the vehicle cabin), the determination section 125 determines that the portable device 20 is positioned inside the vehicle cabin (Step S206), and ends the determination process.

On the other hand, the determination section 125 determines that abnormal values are obtained (Step S212) and ends the determination process in the case where neither of the results of the calculation obtained in Step S208 satisfies the condition (condition that the portable device 20 is positioned inside the vehicle cabin).

Next, description will continue with reference to FIG. 8. In the case where it is determined that the ranging has been successfully performed by the at least two exterior anchors in Step S110 illustrated in FIG. 6, (Yes in Step S110), the determination section 125 according to the present embodiment determines positional relations between the portable device 20 and seats installed in the vehicle cabin, on the basis of ranging values calculated by the plurality of first wireless communication devices 110 disposed on the exterior of the mobile object 10.

More specifically, the determination section 125 determines a seat closer to the portable device 20 (Step S302) on the basis of a first minimum value (smallest ranging value among acquired ranging values) and a second minimum value (second-smallest ranging value among the acquired ranging values) among the ranging values acquired by the exterior anchors.

For example, the determination section 125 may determine that the seat closer to the portable device 20 is a driver’s seat (D) in the case where a ranging value calculated by the first wireless communication device 110A is the first minimum value and a ranging value calculated by the first wireless communication device 110B is the second minimum value.

In addition, for example, the determination section 125 may determine that the seat closer to the portable device 20 is a front passenger seat (P) in the case where a ranging value calculated by the first wireless communication device 110C is the first minimum value and a ranging value calculated by the first wireless communication device 110D is the second minimum value.

In addition, for example, the determination section 125 may determine that the seat closer to the portable device 20 is a rear seat (BD) in the case where a ranging value calculated by the first wireless communication device 110B is the first minimum value and a ranging value calculated by the first wireless communication device 110C is the second minimum value.

In addition, for example, the determination section 125 may determine that the seat closer to the portable device 20 is the front seats (FR) in the case where a ranging value calculated by the first wireless communication device 110A is the first minimum value and a ranging value calculated by the first wireless communication device 110D is the second minimum value.

In addition, for example, the determination section 125 may set a result of determination to “other” in the case where ranging values calculated by the first wireless communication devices 110A and 110C are the first minimum value and ranging values calculated by the first wireless communication devices 110B and 110D are the second minimum value.

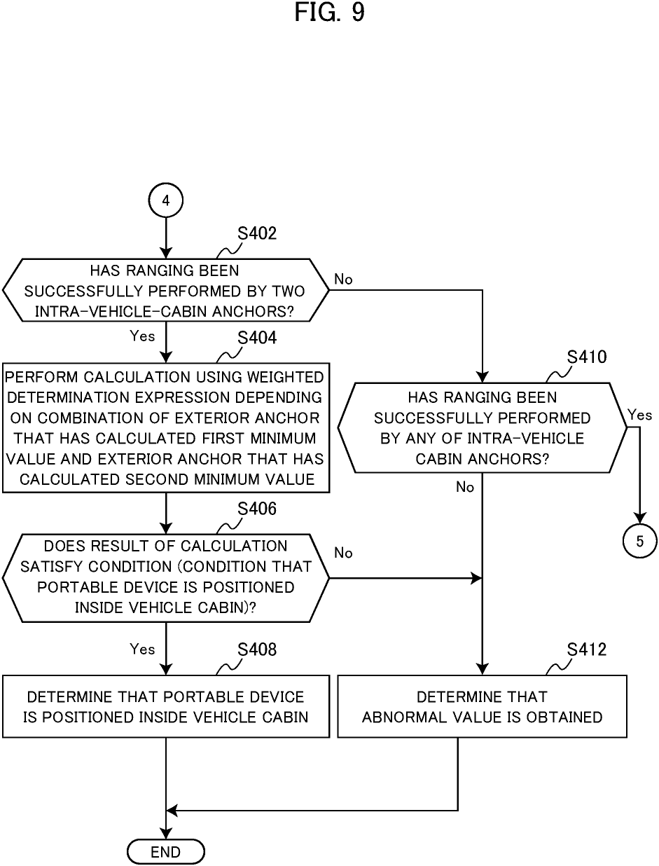

The determination section 125 proceeds to Step S402 illustrated in FIG. 9 in the case where a determination result obtained in Step S302 indicates “other” (“other” in Step S302).

On the other hand, the determination section 125 determines whether or not ranging has been successfully performed by the both intra-vehicle-cabin anchors (Step S304) in the case where the determination result obtained in Step S302 indicates “D”, “P”, “BD”, or “FR” (D/P/BD/FR in Step Section 302).

The determination section 125 proceeds to Step S208 illustrated in FIG. 7 in the case where it has not been determined that the ranging has been successfully performed by the both intra-vehicle-cabin anchors (No in Step S304), that is, in the case where any of the intra-vehicle-cabin anchors has failed to perform ranging.

On the other hand, in the case where it is determined that the ranging has been successfully performed by the both intra-vehicle-cabin anchors (Yes in Step S304), the determination section 125 performs a calculation (Step S306) using a weighted determination expression depending on the seat determined in Step S 302.

In other words, the determination section 125 selects one of the four different weighted determination expressions depending on the seat (D/P/BD/FR) determined in Step S306.

Next, the determination section 125 determines whether or not a result of the calculation obtained in Step S306 satisfies a condition (condition that the portable device 20 is positioned inside the vehicle cabin) (Step S308).

In the case where the result of the calculation satisfies the condition (condition that the portable device 20 is positioned inside the vehicle cabin) (Yes in Step S308), the determination section 125 determines that the portable device 20 is positioned inside the vehicle cabin (Step S310), and ends the determination process.

On the other hand, in the case where the result of the calculation does not satisfy the condition (condition that the portable device 20 is positioned inside the vehicle cabin) (No in Step S308), the determination section 125 determines that the portable device 20 is positioned outside the vehicle cabin (Step S312), and ends the determination process.

Note that, in Step S312, the determination section 125 may determine in which direction the portable device 20 is positioned in outside the portable device 10 on the basis of the seat determined in Step S302.

Next, description will continue with reference to FIG. 9. The determination section 125 determines whether or not ranging has been successfully performed by the both intra-vehicle-cabin anchors (Step S402) in the case where the determination result obtained in Step S302 illustrated in FIG. 8 indicates “other” (“other” in Step Section 302).

In the case where it is determined that the ranging has been successfully performed by the both intra-vehicle-cabin anchors (Yes in Step S402), the determination section 125 performs a calculation using a weighted determination expression depending on a combination of an exterior anchor that has calculated the first minimum value and an exterior anchor that has calculated the second minimum value (Step S404).

In other words, in Step S404, the determination section 125 performs a calculation using a weighted determination expression depending on a combination of the first wireless communication devices 110A and 110C or a combination of the first wireless communication devices 110B and 110D.

Next, the determination section 125 determines whether or not a result of the calculation obtained in Step S404 satisfies a condition (condition that the portable device 20 is positioned inside the vehicle cabin) (Step S406).

In the case where the result of the calculation obtained in Step S404 satisfies the condition (condition that the portable device 20 is positioned inside the vehicle cabin) (Yes in Step S406), the determination section 125 determines that the portable device 20 is positioned inside the vehicle cabin (Step S408), and ends the determination process.

On the other hand, the determination section 125 determines that an abnormal value is obtained (Step S412) and ends the determination process in the case where the result of the calculation obtained in Step S404 does not satisfy the condition (condition that the portable device 20 is positioned inside the vehicle cabin).

Alternatively, the determination section 125 determines whether or not the ranging has been successfully performed by any of the intra-vehicle-cabin anchors (Step S410) in the case where it has not been determined that the ranging has been successfully performed by the both intra-vehicle-cabin anchors in Step S402 (No in Step S402).

The determination section 125 proceeds to Step S208 illustrated in FIG. 7 in the case where it is determined that the ranging has been successfully performed by any of the intra-vehicle-cabin anchors (Yes in Step S410).

On the other hand, the determination section 125 determines that an abnormal value is obtained (Step S412) and ends the determination process in the case where it has not been determined that the ranging has been successfully performed by any of the intra-vehicle-cabin anchors (No in Step S410), that is, in the case where the both intra-vehicle-cabin anchors have failed to perform ranging.

The example of the flow of the area determination of the portable device 20 by the determination system 125 according to the present embodiment has been described above. As described above, the above-described determination method makes it possible to determine the position of the portable device 20 with higher accuracy.

Note that, the flow of the area determination according to the present embodiment may be flexibly modified depending on the number of first wireless communication devices 110, the layout of the first wireless communication devices 110, the position of the specific space, and the like.

In addition, the determination expressions used by the determination section 125 may be flexibly modified under the control using results of determination.

### 2. Supplement

Heretofore, preferred embodiments of the present invention have been described in detail with reference to the appended drawings, but the present invention is not limited thereto. It should be understood by those skilled in the art that various changes and alterations may be made without departing from the spirit and scope of the appended claims.

In addition, the series of processes performed by each of the devices described herein may be achieved by a program stored in a non-transitory computer readable storage medium. For example, each program is loaded into RAM, and executed by a processor such as a CPU when a computer executes each of the program. The storage medium may be a magnetic disk, an optical disc, a magneto-optical disc, flash memory, or the like, for example. Alternatively, the above-described programs may be distributed via a network without using the storage medium, for example.

What is claimed is:

1. A determination device comprising
a determination section configured to determine an area where a portable device is positioned, on a basis of wireless communication between a plurality of first wireless communication devices installed at different portions of a mobile object and a second wireless communication device installed in a portable device, in conformity with a designated communication standard,
wherein the determination section determines the area where the portable device is positioned, by using different determination expressions depending on the respective first wireless communication devices, each of which has successfully calculated an RSSI with regard to a signal received from the second wireless communication device through wireless communication compliant with the designated communication standard and a determination target area.

2. The determination device according to claim 1,
wherein the determination section determines the area where the portable device is positioned, by using a weighted determination expression in which different weights are given to the respective first wireless communication devices, each of which has successfully calculated an RSSI with regard to a signal received from the second wireless communication device through wireless communication compliant with the designated communication standard and a determination target area.

3. The determination device according to claim 2,
wherein the determination section determines the area where the portable device is positioned, by using a weighted determination expression in which different weights are given to the respective first wireless communication devices, each of which has successfully performed ranging through wireless communication with the second wireless communication device in conformity with the designated communication standard.

4. The determination device according to claim 3,
wherein the determination section determines the area where the portable device is positioned, by using a weighted determination expression in which different weights are given to a ranging value and an RSSI that are calculated by a single first wireless communication device.

5. The determination device according to claim 4,
wherein the determination section determines the area where the portable device is positioned, by using a weighted determination expression in which a higher weight is given to an RSSI among a ranging value and the RSSI that are calculated by a single first wireless communication device.

6. The determination device according to claim 3, wherein
at least one or more first wireless communication devices are disposed in a vehicle cabin in the mobile object, in a specific space in the mobile object, and on an exterior of the mobile object, and
the determination section determines whether the portable device is positioned in the vehicle cabin, in the specific space, or outside the mobile object.

7. The determination device according to claim 6,
wherein the determination section determines whether or not the portable device is positioned in the specific space, and then if it is determined that the portable device is not positioned in the specific space, the determination device determines whether the portable device is positioned in the vehicle cabin or outside the mobile object.

8. The determination device according to claim 6,
wherein the specific space includes a trunk of the mobile object.

9. The determination device according to claim 6,
wherein the determination section determines a positional relation between the portable device and a seat installed in the vehicle cabin, on a basis of ranging values calculated by the plurality of first wireless communication devices disposed on the exterior of the mobile object.

10. The determination device according to claim 9,
wherein the determination section determines the area where the portable device is positioned, by using a weighted determination expression in which different weights are given to the respective first wireless communication devices on the basis of the positional relation between the portable device and the seat installed in the vehicle cabin.

11. The determination device according to claim 1,
wherein the designated communication standard includes ultra-wideband wireless communication.

12. A determination method comprising
causing a processor to determine an area where a portable device is positioned, on a basis of wireless communication between a plurality of first wireless communication devices installed at different portions of a mobile object and a second wireless communication device installed in a portable device, in conformity with a designated communication standard,
wherein the determination further includes determining the area where the portable device is positioned, by using different determination expressions depending on the respective first wireless communication devices, each of which has successfully calculated an RSSI with regard to a signal received from the second wireless communication device through wireless communication compliant with the designated communication standard and a determination target area.

13. A determination system comprising:
a plurality of first wireless communication devices installed at different portions of a mobile object;
a second wireless communication device installed in a portable device; and
a determination section configured to determine an area where the portable device is positioned, on a basis of wireless communication between the respective first wireless communication devices and the second wireless communication device in conformity with a designated communication standard,
wherein the determination device determines the area where the portable device is positioned, by using different determination expressions depending on the respective first wireless communication devices, each of which has successfully calculated an RSSI with regard to a signal received from the second wireless communication device through wireless communication compliant with the designated communication standard and a determination target area.
